(19) United States
(12) Patent Application Publication
(10) Pub. No.: US 2009/0031411 A1
(43) Pub. Date: Jan. 29, 2009

(54) Method and sytsem for assuring security of a transaction in a telecommunication network

(75) Inventor: Louis Neau, Chateaugiron (FR)

Correspondence Address: Nixon Peabody LLP, 200 Page Mill Road, Palo Alto, CA, 94306, US

(73) Assignee: VIACCESSW, Paris La Defense Cedex (FR)

(21) Appl. No.: 11/922,054

(22) PCT Filed: Jun. 12, 2006
(86) PCT No.: PCT/FR2006/050548

§ 371 Date: Dec. 11, 2007

(30) Foreign Application Priority Data
Jun. 14, 2005 (FR) 0551603

(51) Int. Cl. H04L 9/32; G06F 21/00

(52) U.S. Cl. 726/10

(57) ABSTRACT

The invention relates to a method for assuring security of a commercial transaction between a terminal (24) and a digital contents distribution system, comprising a commercial server (2) and a rights server (4), the said transaction comprising a step consisting of sending an electronic ticket from the commercial server (2) to the terminal (24) to certify the effective purchase of the right to use a content in response to a purchase request.

The method according to the invention comprises a preliminary step consisting of inserting at least one identifier of at least one beneficiary of the purchased right into the said ticket.

### DOMAIN OF THE INVENTION

The invention is related to the field of distribution of digital contents and more specifically relates to a method for assuring security of a commercial transaction between a terminal and a digital contents distribution system, comprising a commercial server and a rights server, the said transaction comprising a step consisting of sending an electronic ticket from the commercial server to the terminal, to certify the effective purchase of the right to use a content in response to a purchase request.

The invention may be implemented in the context of connected networks (Internet, mobile telephony networks, etc.) or broadcast networks (satellite broadcast television networks, IP networks), in which the exchanged contents are protected by a Conditional Access System (CAS) or by a Digital Rights Management (DRM) system.

### STATE OF PRIOR ART

International application WO 03/049443 A1 published on Jun. 12, 2003 describes a method for supplying an access right to a scrambled content broadcast on a telecommunication network. This method includes the following steps:
transmission of a content access request to an access supply management server,
send a signal by the management server in response to the access request, comprising a broadcast content decryption key and at least one electronic authorization ticket to access the content comprising a unique identifier known to the management server,
reception of an identification signal by the management server comprising the ticket identifier and an identifier of the terminal from which this identification signal was sent, this reception step triggering the step sending the broadcast content decryption key signal.

The exchange of the identification signal between the terminal and the management server as described in international application WO 03/049443 A1 cannot prevent fraudulent interception and modification of the content of the electronic ticket sent by the management server to this terminal.

The purpose of the invention is to overcome the drawbacks of the prior art described above by means of a method for avoiding fraudulent interception and modification of the electronic ticket exchanged between a management server and a terminal or the supply of a false ticket to the terminal.

### PRESENTATION OF THE INVENTION

The invention is based on a method for assuring security of a commercial transaction between a terminal and a digital content distribution system comprising a commercial server and a rights server, said transaction including the following steps:
sending an electronic ticket from the commercial server to the terminal, to certify the effective purchase of the right to use a content in response to a purchase request,
inserting at least one identifier of at least one beneficiary of the purchased right and cryptographic redundancy into the said ticket to enable the rights server to check the authenticity and/or integrity of the content of the electronic ticket.

The method according to the invention may be implemented in a particular context in which the terminal communication with the commercial server through a first application protocol specific to the commercial server, and with the right server through a second application protocol specific to the right server.

According to the invention, the terminal communicates with the said commercial server through a first application protocol specific to the commercial server, and with the said rights server through a second application protocol specific to the rights server, and the said method also comprises a third protocol consisting of:
defining an identifier I1 of the beneficiary with the commercial server and an identifier I2 of the said beneficiary with the rights server,
setting up a correspondence between the identifier I1 and the identifier I2 to enable an exchange between said servers of data related to the beneficiary when identified by one or the other of the identifiers I1 and I2.

According to one variant embodiment of the invention, said cryptographic redundancy may for example be an electronic signature generated using a private key of the commercial server and the authenticity and/or the integrity of the said ticket is checked using a public key of the commercial server provided beforehand to the rights server.

In one particular embodiment of the method according to the invention, the correspondence between the identifiers I1 and I2 is recorded in a database accessible by the commercial server and/or by the rights server.

### BRIEF DESCRIPTION OF THE FIGURES

Other special features and advantages of the invention will become clearer after reading the description given below as a non-limitative example, with reference to the appended drawings, wherein:

FIG. 1 diagrammatically illustrates a digital contents distribution system in which the method according to the invention is used,

FIG. 2 shows an organization chart illustrating the steps in the method according to the invention.

### DETAILED PRESENTATION OF PARTICULAR EMBODIMENTS

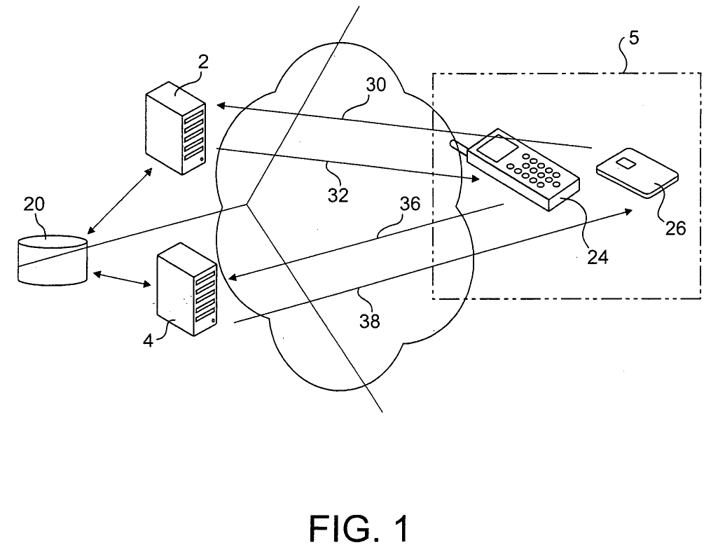

FIG. 1 diagrammatically illustrates a digital content distribution system comprising a commercial server 2, a rights server 4, a database 20 and an exploitation platform 5. The commercial server 2 and the rights server 4 can each be connected to the database 20 and can share information from this database 20.

The rights server 4 may be a Digital Right Management (DRM) server, or a Conditional Access System (CAS). The digital content may represent audio data, video data or multimedia data.

The method according to the invention can be used in a context in which the operations platform 5 comprises one or several rights purchasing terminals and one or several purchased rights beneficiary terminals. In such a platform, the functions of purchasing a right and obtaining this right may be supported by the same terminal or by separate terminals.

For reasons of clarity, the following description relates to an example embodiment illustrated by FIG. 1 in which the exploitation platform 5 comprises a communication terminal 24 that is both purchaser and beneficiary of the right to use a digital content.

In this example embodiment, the communication terminal 24 is a UMTS mobile telephone provided with a SIM (Subscriber Identity Module) card 26 and comprising a purchase module capable of communicating with the commercial server 2 through a first application protocol specific to the commercial server 2, and a module for use of the purchased right capable of communicating with the rights server 4 through a second application protocol specific to the rights server 4. The purchase module is software used to purchase the right and the usage module is software used to obtain the purchased right.

Note that the terminal 24 may be a portable digital agenda (PDA) or a portable computer, without departing from the scope of the invention.

The terminal 24 is identified to the commercial server 2 by a first identifier I1 and to the rights server 4 by a second identifier I2. The identifiers I1 and I2 are previously memorized in the SIM card 26 of terminal 24 and the correspondence between these two identifiers is recorded in a first directory of the database 20. This database also comprises a second directory containing a correspondence list between the services supplied to the terminal 24 and the rights associated with these services.

During operation, the terminal 24 transmits a purchase request to the commercial server 2 (arrow 30), including in particular an identifier of the digital content concerned and the identifier I1 of the beneficiary, in fact the identifier I1 of terminal 24. When this request is received, the commercial server 2 generates an electronic ticket comprising the content identifier, inserts the identifier of the beneficiary in this electronic ticket and sends this ticket (arrow 32) to the terminal 24.

In a first embodiment, the identifier of the beneficiary inserted into the ticket is identifier 12 determined by the commercial server starting from the base 20 in correspondence with the identifier I1. In another embodiment, the identifier of the beneficiary inserted in the ticket is identifier I1 received by the commercial server in the purchase request.

To enable the beneficiary to access the content, the ticket is sent from the terminal 24 to the rights server 4 (arrow 36), as it was received from the commercial server 2 without any modification. Thus, the terminal 24 acts exclusively as a router during this transaction. To achieve this, the ticket may also contain the designation of the server(s) to which the beneficiary's terminal will have to connect to obtain the content and the associated rights, while remaining within the scope of the invention.

When the rights server 4 receives the ticket, the rights server determines the beneficiary of the right corresponding to the ticket. In the first embodiment in which the ticket contains the beneficiary's identifier I2, the beneficiary is directly identified by this identifier. In the second embodiment in which the ticket contains the beneficiary's identifier I1, the rights server 4 uses the database 20 to determine the identifier I2 of the beneficiary in advance by correspondence with the identifier I1 received in the electronic ticket. When the beneficiary has been identified, the rights server generates the right related to the content identified in the ticket and sends the generated right to the terminal 24 (arrow 38).

It can thus be understood that the beneficiary of the purchased right is the beneficiary specifically denoted in the ticket, which prevents a third party from using this ticket for his own benefit.

Advantageously, the commercial server 2 associates a cryptographic redundancy with the electronic ticket so that the rights server 4 will be able to check the authenticity and/or integrity of the content of the said ticket. The said cryptographic redundancy may for example be an electronic signature generated using a private key of the commercial server 2. The authenticity and/or integrity of the said ticket is checked using a public key of the commercial server 2 provided beforehand to the rights server 4.

In this case, when the ticket is received by the rights server 4, the right server checks the cryptographic redundancy to check the authenticity and integrity of the said ticket. If the cryptographic redundancy of the received ticket is correct, the rights server identifies the beneficiary, and then generates and sends the right corresponding to the ticket as described above.

It can thus be understood that the ticket cannot be modified before it is submitted to the rights server, for example either by the beneficiary changing the identifier of the content to obtain a different content, or by a third party replacing the identifier of the beneficiary by his own identifier if he has been able to expose the ticket. It can easily be understood that a false ticket not generated by the commercial server is refused by the rights server and cannot be used to obtain a right to access a content.

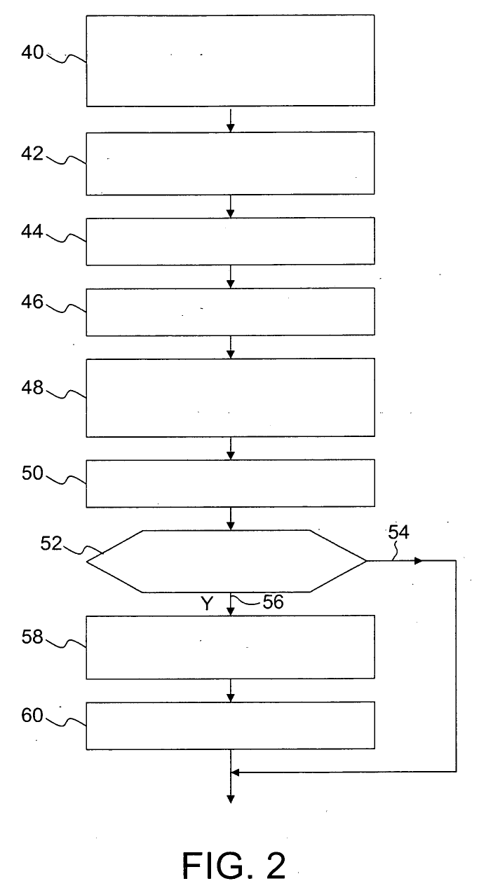

The flow chart in FIG. 2 shows the steps to assure security of the electronic ticket generated by the commercial server 2 in a transaction during which, for example, the purchaser of the usage right is not the beneficiary of the purchased right.

In this context, a right is purchased through a terminal of the purchaser and the purchased right is obtained in a terminal of the beneficiary of the right.

The purchaser transmits the purchase request to the commercial server (step 40), in particular containing the identifier of the digital content and the identifier of the beneficiary of this content. When this request is received, the commercial server 2 generates an electronic ticket (step 42) comprising the identifier of the content and inserts the identifier of the beneficiary in the generated ticket (step 44). This functional security of the ticket assures that use of the purchased digital content is exclusive to the sole beneficiary denoted on the ticket.

Optionally in step 46, the commercial server 2 generates an electronic signature of the ticket and associates this signature with the content of the ticket built up during the previous step. This technical security of the ticket enables the rights server 4 to check the authenticity and integrity of the content of this ticket. The said electronic signature is made using a private key of the commercial server 2 and the authenticity and integrity of the said ticket are checked using a public key of the commercial server 2 provided beforehand to the rights server 4.

With this procedure, the integrity of the ticket is guaranteed and the commercial server 2 is authenticated as the ticket issuer.

In step 48, the commercial server 2 sends the secured ticket to the beneficiary's terminal. Note that steps 40 to 48 use the transport, application, dialogue and security protocols specific to the commercial server 2.

To enable the beneficiary to access the content, the ticket is sent to the rights server 4 (step 50) as the commercial server 2 received it.

In step 52, the rights server 4 verifies the signature contained in the ticket and checks the authenticity and integrity of the said ticket.

If the ticket is not authentic or is not complete (arrow 54), the rights server 4 refuses to deliver the right to the beneficiary.

If the ticket is authentic and complete (arrow 56), the rights server 4 issues the right to the beneficiary.

In the particular embodiment described above, the usage right is supplied to the beneficiary only if the ticket integrity and authenticity is checked. If the ticket does not include cryptographic redundancy, steps 50 and 52 and the arrow 54 are ignored.

The rights server 4 generates this right (step 58) as a function of the received ticket taking account particularly of:
the correspondence between the identifier of the beneficiary with the commercial server 2 and the identifier of this beneficiary with the rights server 4;
the correspondence between the identifier of the requested content and the usage rights corresponding to marketing of this content.

The rights server sends the generated right to the beneficiary in step 60.

Note that steps 48 to 60 use transport, application, dialogue and security protocols specific to the rights server 4.

The embodiment described above enables a secure exchange of the electronic ticket from end to end independently of the application and security protocols of the commercial server 2 and the application and security protocols of the rights server 4.

1. Method for assuring security of a commercial transaction between a terminal (24) and a digital content distribution system comprising a commercial server (2) and a rights server (4), the said transaction including the following steps:
sending an electronic ticket from the commercial server (2) to the terminal, to certify the effective purchase of the right to use a content in response to a purchase request,
inserting at least one identifier of at least one beneficiary of the purchased right and cryptographic redundancy into the said ticket to enable the rights server (4) to check the authenticity and/or integrity of the content of the electronic ticket, characterized in that the terminal (24) communicates with the said commercial server (2) through a first application protocol specific to the commercial server (2), and with the said rights server (4) through a second application protocol specific to the rights server (4), and in that the said method also comprises a third protocol consisting of:
defining an identifier I1 of the beneficiary with the commercial server (2) and an identifier I2 of the said beneficiary with the rights server (4),
setting up a correspondence between the identifier I1 and the identifier I2 to enable an exchange of data related to the beneficiary identified by one or the other of the identifiers I1 and I2, between the said servers (2, 4).

2. Method according to claim 1, in which the said cryptographic redundancy is an electronic signature generated using a private key of the commercial server (2) and in that the authenticity and/or the integrity of the said ticket is checked using a public key of the commercial server (2) provided beforehand to the rights server (4).

3. Method according to claim 2 in which the said correspondence is recorded in a database (20) accessible by the commercial server (2) and/or by the rights server (4).
